(19) United States
(12) Patent Application Publication
(10) Pub. No.: US 2024/0378655 A1
(43) Pub. Date: Nov. 14, 2024

(54) SYSTEM AND METHOD FOR DEALS PIPELINE OPTIMIZATION

(71) Applicant: GONG.io Ltd., Ramat Gan (IL)

(72) Inventors: Guy Netser EYAL, Jerusalem (IL); Nadav Shai Oved SHALEV, Tel Mond (IL); Shlomi MEDALION, Lod (IL); Inbal HOREV, Tel Aviv (IL); Eyal BEN-DAVID, Kibbutz Yagur (IL)

(73) Assignee: GONG.io Ltd., Ramat Gan (IL)

(21) Appl. No.: 18/661,097

(22) Filed: May 10, 2024

Related U.S. Application Data
(60) Provisional application No. 63/501,857, filed on May 12, 2023.

(51) Int. Cl. G06Q 30/0601; G06N 5/02

(52) U.S. Cl. CPC G06Q 30/0631; G06N 5/02

(57) ABSTRACT

A system and method for streamlining a deal pipeline based on large language models are provided. The method includes encoding an input query into a numerical representation in a business domain; retrieving data from a deal knowledge base based on the numerical representation; generating a prompt based on the encoded input query and data retrieved from the knowledge base; feeding the prompt to a generic-trained language model; and ranking responses provided by the generic-trained language model, wherein the responses are related to at least a deal pipeline.

### CROSS-REFERENCE TO RELATED APPLICATIONS

This application claims the benefit of U.S. Provisional Application No. 63/501,857 on May 12, 2023, the contents of which are hereby incorporated by reference.

### TECHNICAL FIELD

The present disclosure generally relates to the field of machine learning techniques and more specifically for optimizing a deal process.

### BACKGROUND

A sales pipeline visualizes a potential buyer's journey through the sales process from prospect (i.e., potential customers) to buyer. This gives sales professionals a quick snapshot of which stage a deal is at, helping them focus their efforts on the best opportunities and to strategize effectively. During various stages of the pipeline, sales professionals often communicate with prospects through different channels, including phone calls, text messages, emails, and the like. As such, sales professionals manually create numerous messages (that may be delivered via textual, audio, or video channels) tailored to different prospects and stages of the pipeline. Such messages may be in the form of a playbook to answer the prospects' questions during conversations about a product, best practices, and negotiation tactics. Currently, the way that sales communication messages are created is time-consuming. One approach is to use pre-configured templates. However, such templates are not designed or updated based on the context of conversations between sales professionals and prospects.

Completing a successful deal requires sales professionals to conduct many steps at various stages of the deal process. However, due to weak deal management, sales professionals may skip or forget important steps of a deal which may reduce the likelihood of the deal closing. The final stages of a deal pipeline are also crucial to its success. The pipeline is designed to reach the stage where an offer can be extended with the best possible understanding of the prospect's needs and goals. Successfully closing a deal depends on providing an accurate offer that is tailored to the prospect's needs and financial situation. Sometimes sales professionals may use a particular pricing model or strategy in their offer that does not appeal to the prospect. This creates a risk of losing the deal or the deal failing to achieve its full potential.

It would, therefore, be advantageous to provide a solution that would overcome the challenges noted above.

### SUMMARY

A summary of several example embodiments of the disclosure follows. This summary is provided for the convenience of the reader in order to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for streamlining a deal pipeline based on large language models. The method comprises: encoding an input query into a numerical representation in a business domain; retrieving data from a deal knowledge base based on the numerical representation; generating a prompt based on the encoded input query and data retrieved from the knowledge base; feeding the prompt to a generic-trained language model; and ranking responses provided by the generic-trained language model, wherein the responses are related to at least a deal pipeline.

Certain embodiments disclosed herein also include a non-transitory computer-readable medium having stored thereon causing a processing circuitry to execute a process, the process comprising: encoding an input query into a numerical representation in a business domain; retrieving data from a deal knowledge base based on the numerical representation; generating a prompt based on the encoded input query and data retrieved from the knowledge base; feeding the prompt to a generic-trained language model; and ranking responses provided by the generic-trained language model, wherein the responses are related to at least a deal pipeline.

Certain embodiments disclosed herein also include a system for streamlining a deal pipeline based on large language models. The system comprises: a processing circuitry; and a memory, the memory containing instructions that, when executed by the processing circuitry, configure the system to: encode an input query into a numerical representation in a business domain; retrieve data from a deal knowledge base based on the numerical representation; generate a prompt based on the encoded input query and data retrieved from the knowledge base; feed the prompt to a generic-trained language model; and rank responses provided by the generic-trained language model, wherein the responses are related to at least a deal pipeline.

### BRIEF DESCRIPTION OF THE DRAWINGS

The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is an example flowchart illustrating the generation of an output response through an input query according to an example embodiment.

FIG. 3 is a flowchart illustrating the generation of matching message data according to an example embodiment.

FIG. 4 is a flowchart illustrating the generation of an optimized response according to an example embodiment.

FIG. 5 is a flowchart illustrating the generation of a recommended next action according to an example embodiment.

FIG. 6 is a flowchart illustrating the generation of an optimal offer according to an example embodiment.

FIG. 7 is a schematic diagram of a system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, numerals refer to like parts through several views.

The various disclosed embodiments provide techniques for streamlining a deal pipeline using an encoder and a generic-trained language model (hereinafter “GLLM”). The encoder is a model trained on sales data related to a specific customer or a group of customers. The model is trained to generate a vector (e.g., in a numerical representation) in response to an input text. In an embodiment, the encoder is utilized for encoding a current message/conversation and for searching for similar data (in the CRM/history/etc.) that was also encoded in the same method using some similarity method that represents semantic similarity. The encoder may be realized, such as, but not limited to, Sbert, GPT, TSDAE, SimCSE, and the like. The GLLM may be any commercial language model trained on a large data corpus to output a textual message in response to a prompt. An example of the GLLM may include Generative Pre-trained Transformer (GPT) 3 and Generative Pre-trained (GPT) 4, which are language models developed by OpenAl.

The accuracy of the GLLM's output is determined by the prompt fed to the model. Further, the processing time of the GLLM depends on the length (number of words) of the prompt. According to the disclosed embodiments, the encoder is utilized to provide an accurate and concise prompt to the GLLM. Engineering the prompt using the disclosed embodiment provides an accurate message that would streamline sales processes, and improve the productivity of sales professionals while conserving computing resources for optimizing sales cycles and deals pipelines.

In some embodiments, the disclosed system is configured to receive data of a user's communication with a prospect and is configured to generate at least one optimal response. The optimal response is an answer to the previous communication between the prospect and the user, in which the answer is an answer with the most probable outcome for a deal to be agreed upon between the prospect and the user. The response may be in the format of an email, a text message, and the like. In an embodiment, the user is at least one of a sales representative, an account executive, a sales development representative (SDR), and the like, which may be a single employee, a plurality of employees, a team, and the like. The system disclosed herein is further configured to generate the optimal response by using a deal knowledge base that may include data on similar stages, similar deals, similar characteristics of prospects, and previously generated successful responses. The response is also generated by factoring information communication with the prospects and CRM data related to the current deal. The communication with the prospects may include past communication (such as call transcripts, emails, messages, etc.) or real-time communication (such as an ongoing sales call).

The disclosed embodiments can be utilized to describe various types of responses that would improve closing rates of deals and the productivity of sales representatives. In one embodiment, the response may include a fully worded message. In yet another embodiment, the response may include an answer to a question, comment, or query made by a prospect during a call. In yet another embodiment, the response may include a recommendation for the next best action with respect to the prospect. Such responses may be generated using a causal inference model. In yet another embodiment, the response may include an offer generated for the prospect.

In an embodiment, the responses and/or recommendations generated according to the disclosed embodiments are ranked based on various factors. For example, such factors may include contextual similarity between the generated response and the input query. Top-ranked responses are likely to improve the closing rates of deals.

Technical improvements of the disclosed system include the automation of various tasks for sales professionals to improve the efficiency of the deal pipeline process and increase the overall number and rate of successful deals. Further, the disclosed system guides sales professionals on communications with prospects and recommends the next best action steps and best pricing for deal offers. In order to provide such guidance and automate tasks for sales professionals the system must process historical data, customer relationship management (CRM) data, textual communication data, deal stages, and significant events. Thus, the system can process vast amounts of data and perform data analysis at an incredible speed and accuracy far surpassing human capabilities.

Therefore, it should be understood that the operations described herein cannot be performed using the human mind or by performing the operation using paper and pencil. Moreover, a human operator applies subjective criteria to select/simulate/predict, leading to results that are not consistent between different human operators and often not consistent between the same human performing the same task repeatedly, and in particular at the speeds required to provide an operable solution. The number of possible permutations for potential deal actions and pricing models based on deal communications, historical data, customer relationship management data, deal stages, and other significant events far exceeds any practical use of the human mind.

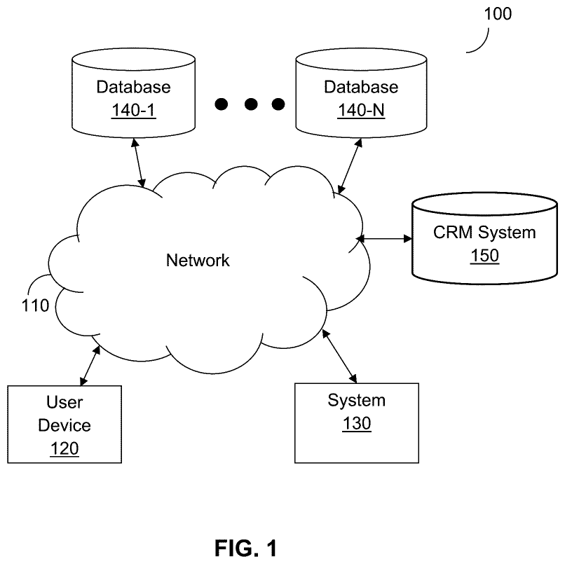

FIG. 1 shows an example network diagram 100 utilized to describe the various disclosed embodiments. In the example network diagram 100, a plurality of databases 140-1 through 140-N (hereinafter referred to individually as a database 140 and collectively as databases 140, merely for simplicity purposes), a system 130, a user device 120, and a customer relationship management (CRM) system 150, communicate via a network 110. The network 110 may include but is not limited to, a wireless, cellular, or wired network, a local area network (LAN), a wide area network (WAN), a metro area network (MAN), the Internet, the world wide web (WWW), similar networks, and any combination thereof.

The user device 120 may be but is not limited to, a personal computer, a laptop, a tablet computer, a smartphone, a wearable computing device, or any other device capable of receiving and displaying the generated recommendations. Depending on the stage of the deal pipeline, the generated response may be, for example, message data, an optimal answer, a recommended next action, a recommended offer, and the like. The user device 120 is configured to display the generated responses in a natural language to a user (e.g., a sales representative, a sales team, an account executive, an employee, etc.).

A database 140 is configured to store message data that may be related to conversations, for example, but not limited to, between prospects and users of a company (i.e., employees). Such message data may include but is not limited to, electronic mail (email) messages, chat logs, instant messages, or other text, or data otherwise, including contents of communications or content related to communications between and among individuals. The message data may be realized as types of communication such as, but not limited to, emails, short message service (SMS) messages, text messages, instant messages, social media posts; calls statistics (e.g., who spoke, how much, and when), portions thereof, and the like. Such message data may, therefore, include information indicating that follow-up or summarizing is desired, for example, in order to complete a sale or to provide assistance. As noted above, a significant amount of such message data may be generated on any given day, particularly for large call centers with hundreds or thousands of users.

A database 140 may further include a deal communication knowledge base (or DKB). The DKB stores data that may be provided as a reference to generate the best response. Such data may include but is not limited to, similar deals, similar prospects (their personas), similar deals at a certain stage of the deal, and similar pricing models. The data in DKB may further include successful responses (e.g., offers, messages, next actions, answers, etc.). The DKB may further include references for users' inputs (e.g., similar questions, previous conversations, etc.). The data retrieved from the DKB is based on the type of response to be generated.

System 130 is configured to process the data in database 140 and prospect data obtained from CRM system 150 to generate one of the responses mentioned above. To this end, in accordance with various disclosed embodiments, system 130 is configured to train and run the encoder. The encoder (not shown in FIG. 1) is configured to jointly represent deal metadata and CRM data with textual data from message data (e.g., calls and emails in the natural language in a single model, and encode linguistic information that is relevant to the prospects' business domain. The generator is further configured to run a GLLM. The GLLM is configured to generate well-formed output texts in natural language for different purposes while receiving relevant message data and prospect CRM data.

In an embodiment, the system 130 is also configured to retrieve information from the database 140, including at least call transcript data, message data, and customer data. Such information is of a specific prospect and a call. The system 130 is further configured to process data at the conversation level. In addition, the system 130 may process correspondence data (e.g., emails, text messages, instant messages (IMs), etc.) and data at a deal level, for example, from a CRM system 150.

In an embodiment, the system 130 is configured to correlate data collected during communications with the prospect to the CRM system 150 and produce a timeline of events for each deal. The system 130 is further configured to curate relevant data, search for similar prospect profiles and similar deals, and learn which features correlate with successful communication and successful outcomes per deal. The system 130 is further configured to generate recommendations to the sales representative based on data in the DKB and continues to learn from deal outcomes and feedback.

The system 130 is further configured to jointly represent deal metadata and CRM data with textual data from calls and emails (natural language) in a single model, which encodes linguistic information which is relevant to the customer's business domain.

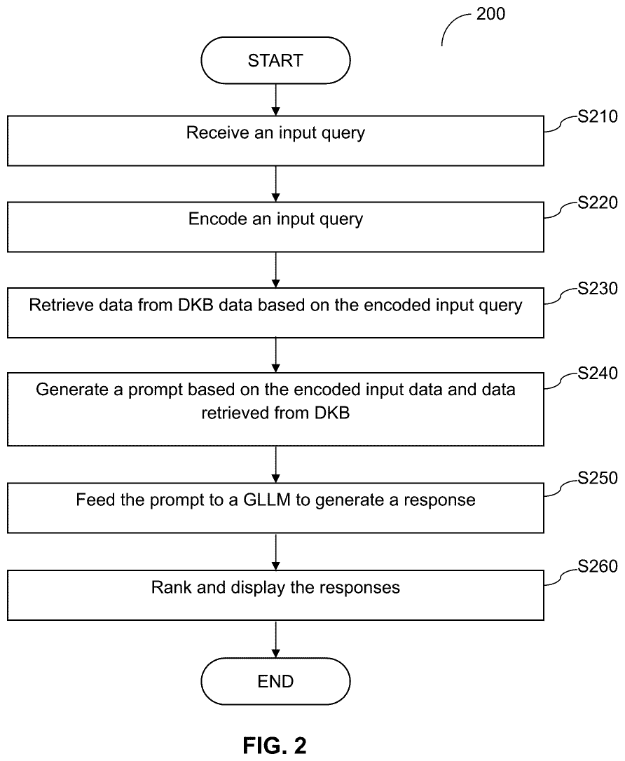

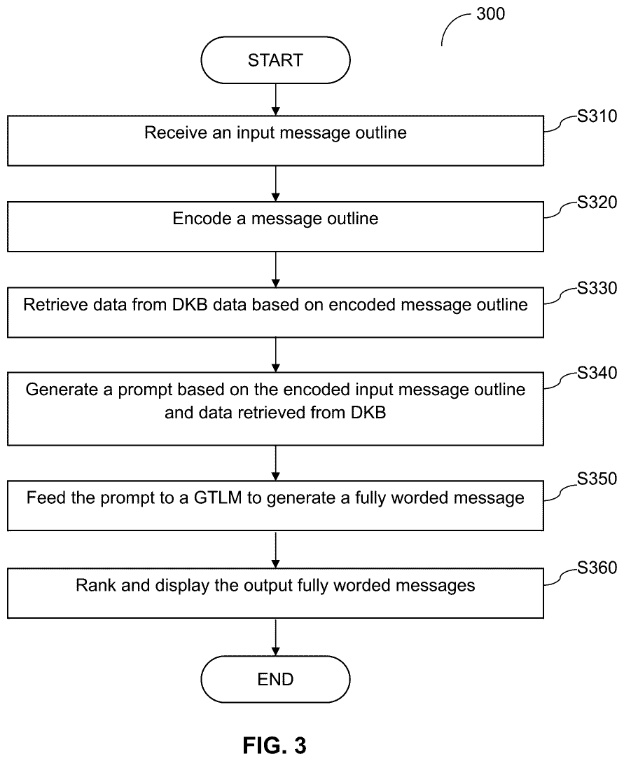

The system 130 is further configured to run a GLLM to automatically generate well-formed output texts in natural language for different purposes while receiving relevant customer data from the components above in its prompt. The operation of the system 130 will be described with reference to FIG. 2, while the use cases will be discussed with reference to FIGS. 3 through 5. It should be noted that the implementation shown in FIG. 1 is just an example and that at least some of the disclosed embodiments are not limited to the particular configurations and arrangements discussed in FIG. 1.

FIG. 2 shows an example flowchart 200 for deals pipeline optimization according to an embodiment. At S210, an input query is received from a user device. The input query is provided by a user seeking a response to optimize the deal. In an embodiment, the input query may be any one of a message outline, a question, a desired outcome for a given state of a deal, a goal, and so on. Each such input query would trigger a different type of response.

At S220, the input query is encoded into a numerical representation to encode linguistics relevant to the customer's business domain. As noted above, the encoder is trained on specific data related to a specific customer, group of customers, and historical deals; thus, the encoded input query relates to the customer business domain.

At S230, using the encoded input query, deal information is retrieved from the DKB. The information may include any piece of information saved in the DKB and may be used to generate the response. Examples of these are provided below.

At S240, a prompt is engineered or generated based on the encoded input query and deals with information retrieved from the DKB. The prompt is generated based on the target GLLM. A prompt typically includes a command and a text that the command operates on. For example, a prompt command may include “Rephrase,” “Format,” “Reword,” “Answer the question,” “Suggest a solution,” and the like. A prompt may include more than one command. The text that the command operates on includes the encoded input query and deal information. In an embodiment, the prompt engineering may include retrieving a smaller number of examples from the DKB to decrease the prompt length. In another embodiment, prompt engineering includes retrieving examples prior to receiving the full query from the user (retrieving similar examples can be done based on context). In yet another embodiment, prompt engineering includes reducing the size of the DKB based on the conversation context. Alternatively or collectively, prompt engineering may include fast-generation methods such as early exit and greedy decoding.

At S250, the generated prompt is fed to the GLLM to generate a response to the input query. The response includes any one of a fully worded message, an answer to a question, comment, or query made by a prospect during the call, a recommendation for the next best action with respect to the prospect, and an offer generated for the prospect. In an embodiment, S250 may include running a casual inference model through the model. A causal inference model is a statistical model used to determine the causal relationships between variables in a dataset.

At S260, the response is displayed to the user (e.g., a sales representative), for example, over the user device 120 and/or stored in a DKB. In an embodiment, the generated response may be utilized to train the encoder.

FIG. 3 shows an example flowchart 300 for deals pipeline optimization where matching fully worded messages are generated according to an embodiment.

At S310, an input message outline is received from a user. Here, the input message outline includes an outline of a fully worded message phrased in natural language. The input message pertains to a deal in progress. Here, the message outline includes an input query.

At S320, the input message outline is encoded into a numerical representation to encode linguistics relevant to the customer's business domain. To this end, a prompt is engineered and fed to the encoder. The prompt may include the input message outline and deal with data retrieved from a CRM system. In an embodiment, the prompt may include transcript data, message data, and/or customer data. As noted above, the encoder is trained on specific data related to a specific customer, thus, the encoded input message outline relates to the customer business domain.

At S330, using the encoded input message outline, deal information is retrieved from the DKB. In the embodiment, any similar message outlines, similar deals, and previously generated successful worded messages are retrieved from the DKB.

At S340, a prompt is engineered or generated based on the encoded input message outline and information retrieved from the DKB. The prompt is generated based on the target GLLM. In this embodiment, the prompt's command may be “Reword,” and the text that the command operates on may include the encoded input message outline together with retrieved successful messages for similar deals. It should be noted that engineering the prompt to provide such detailed text allows for generating accurate outputs from the GLLM at fewer iterations.

At S350, the generated prompt is fed to the GLLM to generate a fully worded message to the input message outline. The fully worked message may include an email message, a text message, an IM message, and the like.

At S360, the output of a fully worded message is displayed to the user (e.g., a sales representative), for example, over the user's device 120. In an embodiment, the user may score the output message, and messages with a score over a predefined threshold may be stored in a DKB as successful messages. In an embodiment, such a successful message may be utilized to train the encoder.

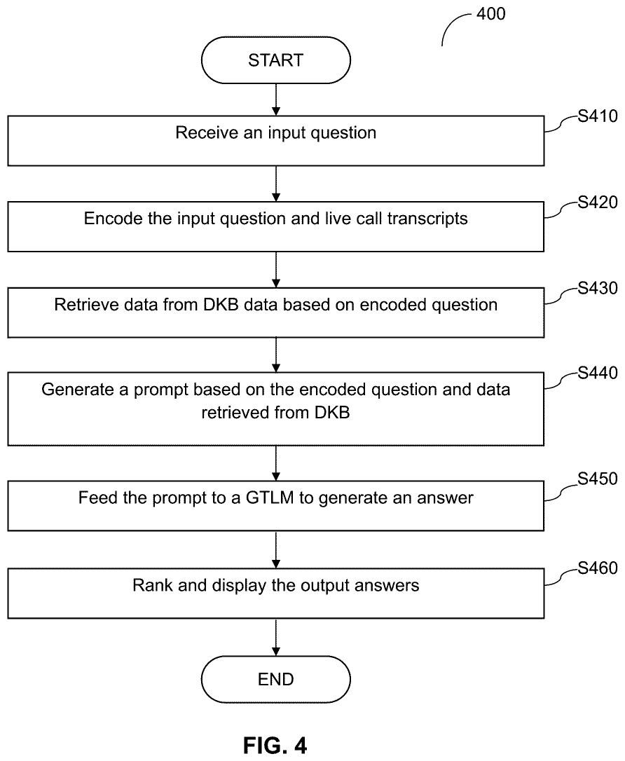

FIG. 4 shows an example flowchart 400 for deals pipeline optimization where answers are generated to questions asked during a live sales call according to an embodiment.

At S410, an input question is received from a user. Here the input question includes an input query by a user.

At S420, the input question is encoded into a numerical representation to encode linguistics relevant to the customer's business domain. To this end, a prompt is engineered and fed to the encoder. The prompt may include the input question (query) and live call transcripts. As noted above, the encoder is trained on specific data related to a specific customer, thus, the encoded input question relates to the customer business domain.

At S430, using the encoded input query, deal information is retrieved from the DKB. In the embodiment, any similar pairs of question-answers, similar prospects, and previously generated best answers are retrieved from the DKB.

At S440, a prompt is engineered or generated based on the encoded input question and information retrieved from the DKB. The prompt is generated based on the target GLLM. In this embodiment, the prompt's command may be “Rephrase,” and the text that the command operates on may include the encoded input question together with retrieved similar successful answers-questions given similar prospects. In an embodiment, the similar successful answers-questions given similar prospects are ranked, and only the top-ranked pair is used for the prompt.

At S450, the generated prompt is fed to the GLLM to generate an answer to the input question. The input question is asked by the prospect during a live call, and as such, the GLLM should provide output to the answer in real-time. To allow for that, the prompt is engineered to allow short-time processing by the GLLM. Additional prompt engineering techniques are disclosed in greater detail above.

At S460, the output message is displayed to the user (e.g., a sales representative), for example, over the user device 120. In an embodiment, the user may score or rank the output answer, and messages with a score over a predefined threshold may be stored in a DKB as a successful answer. In an embodiment, such a successful answer may be utilized to train the encoder or improve the ranking process.

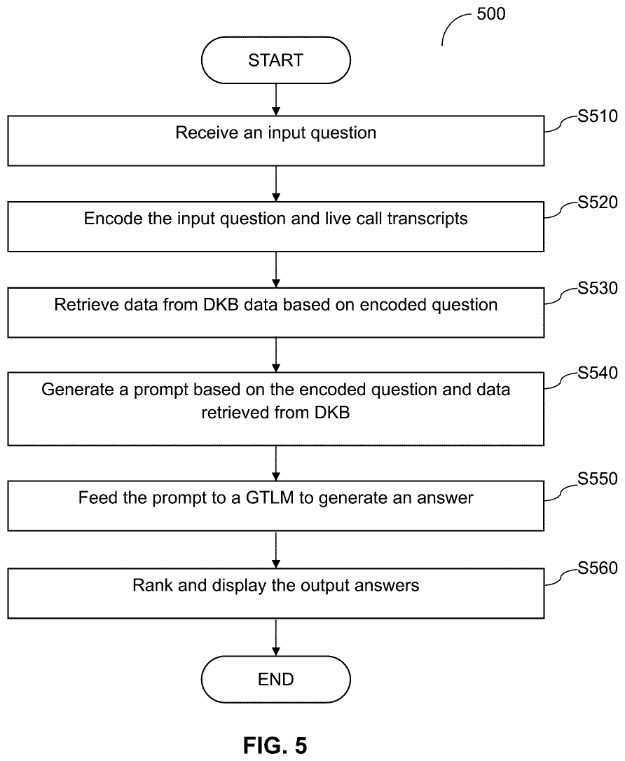

FIG. 5 shows an example flowchart 500 for deals pipeline optimization where the best actions are generated with respect to the current state of a deal according to an embodiment.

At S510, an input question is received from a user. Here, the input question includes an input query about the following action to take at the given stage of the deal. To this end, the user may provide, as part of the input question, the prospect CRM details, the current deal stage, and the desired outcome.

At S520, the input question is encoded into a numerical representation to encode linguistics relevant to the customer's business domain. To this end, a prompt is engineered and fed to the encoder. The prompt may include the input question. In an embodiment, the prompt to the encoder may be enriched with transcript data, message data, and/or customer data. As noted above, the encoder is trained on specific data related to a specific customer, thus, the encoded input question relates to the customer business domain.

At S530, using the encoded input question, deal information is retrieved from the DKB. In the embodiment, any similar deals at the same stage, similar prospects, and previously generated best actions are retrieved from the DKB.

At S540, a prompt is engineered or generated based on the encoded input question and information retrieved from the DKB. In the embodiment, the prompt is a possible action space generated by encoding similar deals and prospects embeddings along successful actions at the deal stage defined in the playbook. Additional prompt engineering techniques that can be utilized herein are discussed above.

At S550, the prompt is fed to the causal inference model, which outputs the following action. It should be noted that the following recommended action may include the following actions of the required sentiment for the next answer urgency, the pricing, and so on. A causal inference model is a statistical model used to determine the causal relationships between variables in a dataset. Causal inference models are used to identify whether changes in one variable cause changes in another. The causal inference model evaluates which of the following actions would increase the deal's win probability given the deal stage, past communications, and how such actions were performed in similar past deals. The action with the biggest positive causal impact on the deal win probability will be the recommended output action.

At S560, the output following action is displayed to the user (e.g., an account executive), for example, over the user device 120. In an embodiment, the user may score or rank the recommended action, and actions having a score over a predefined threshold may be stored in a DKB as a successful action. In an embodiment, such a successful answer may be utilized to train the encoder.

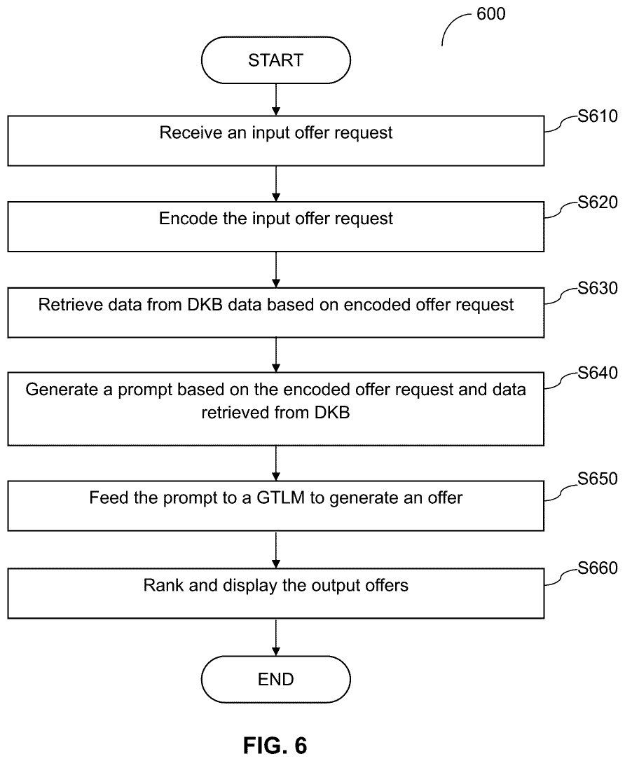

FIG. 6 shows an example flowchart 600 for deals pipeline optimization where offers are generated for prospects according to an embodiment.

At S610, an input offer request is received from a user. Here the input offer request may include an input query. The input offer includes a request by a user to extend an offer to a prospect. The user also provides data from a CRM system about the prospects and the desired goals.

At S620, the input offer request is encoded into a numerical representation to encode linguistics relevant to the customer's business domain. To this end, a prompt is engineered and fed to the encoder. The prompt may include the input offer request. In an embodiment, the prompt to the encoder may be enriched with transcript data, message data, and/or customer data. As noted above, the encoder is trained on specific data related to a specific customer, thus, the encoded input query relates to the customer business domain.

At S630, using the encoded input offer request, deal information is retrieved from the DKB. In the embodiment, any successful pricing models, similar prospects' offers, and previous conversations with the prospect are retrieved from the DKB.

At S640, a prompt is engineered or generated based on the encoded input offer request and information retrieved from the DKB. The prompt is generated based on the target GLLM. In this embodiment, the prompt's command may be “Write”, and the text that the command operates on may include the encoded input query together with pricing-related snippets from previous communications, pricing model templates, and similar prospect offers. Additional prompt engineering techniques that can be utilized herein are discussed above.

At S650, the generated prompt is fed to the GLLM to generate an offer to the input offer request. At S660, the generated offer is displayed to the user (e.g., an account executive), for example, over the user device 120. The user approves sending the offer to the prospect.

At S660, the output offer is displayed to the user (e.g., a sales representative), for example, over the user device 120. In an embodiment, the user may score or rank the output offer with a score over a predefined threshold that may be stored in a DKB as a recommended offer. In an embodiment, such a recommended offer can be utilized to train the encoder or improve the ranking process.

It should be noted that the example embodiments described herein for different stages of the deal pipeline are presented for illustrative purposes and should not limit the scope of the disclosed embodiments.

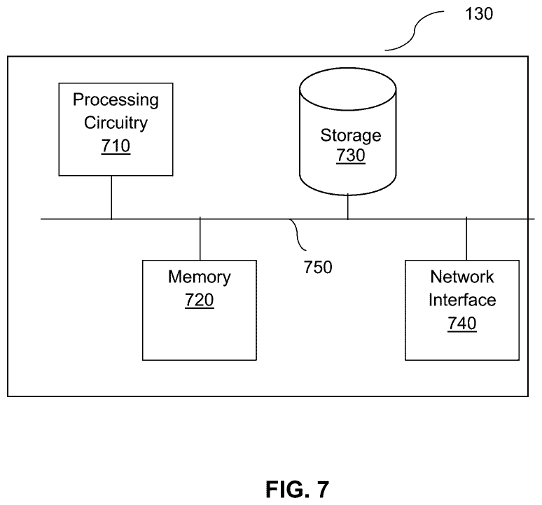

FIG. 7 is an example schematic diagram of the system 130 according to an embodiment. The system 130 includes a processing circuitry 710 coupled to a memory 720, a storage 730, and a network interface 740. In an embodiment, the components of the system 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphic processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read-only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the system 130 to communicate with, for example, the databases 140, the user device 120, and the like.

It should be understood that the embodiments described herein are not limited to the specific architecture illustrated in FIG. 7, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for streamlining a deal pipeline based on large language models, comprising:
encoding an input query into a numerical representation in a business domain;
retrieving data from a deal knowledge base based on the numerical representation;
generating a prompt based on the encoded input query and data retrieved from the deal knowledge base;
feeding the prompt to a generic-trained language model; and
ranking responses provided by the generic-trained language model, wherein the responses are related to at least a deal pipeline.

2. The method of claim 1, wherein the responses include fully worded messages related to deal stages for different prospects.

3. The method of claim 2, further comprising:
generating fully worded messages.

4. The method of claim 3, further comprising:
encoding an input message outline with customer relationship management data;
retrieving data from a deal knowledge base based on an encoded input message outline;
generating a prompt based on the encoded input message outline and data retrieved from the deal knowledge base;
feeding the prompt to a generic-trained language model to generate fully worded messages; and
ranking and displaying the fully worded messages.

5. The method of claim 4, wherein the deal knowledge base includes information on similar message outlines, similar deals, and previously worded messages to prospects.

6. The method of claim 1, wherein the responses include at least one offer to purchase a product or service tailored for a prospect.

7. The method of claim 6, further comprising:
generating the at least one offer.

8. The method of claim 7, further comprising:
encoding an input offer request with customer relationship management data;
retrieving data from a deal knowledge base based on an encoded offer request;
generating a prompt based on an encoded offer request and data retrieved from the deal knowledge base;
feeding the prompt to a generic-trained language model to generate offers tailored for specific prospects; and
ranking and displaying the tailored offers.

9. The method of claim 8, wherein the deal knowledge base includes information on similar pricing models from previous deals, similar offers, previous offers from prospects, and previous conversations with a prospect.

10. The method of claim 1, wherein the responses include answers to questions asked by prospects during a live call.

11. The method of claim 10, further comprising:
generating an answer response during a live call.

12. The method of claim 11, further comprising:
encoding an input question with live call transcripts;
retrieving data from a deal knowledge base based on an encoded input question, wherein such retrieved data includes question and answer pairs;
generating a prompt based on the encoded input question and data retrieved from the deal knowledge base;
feeding the prompt to a generic-trained language model to generate answer responses;
ranking the answer responses; and
rephrasing and displaying a highest scoring answer response.

13. The method of claim 12, wherein the deal knowledge base includes similar pairs of deal questions and answers, similar prospects, and previously generated answer responses.

14. The method of claim 1, further comprising:
generating a next action recommendation to assist with closing a deal based on a stage of a deal, prospect information, and correlating the stage of the deal and prospect information with similar deals at the same stage.

15. The method of claim 14, further comprising:
encoding an input question with customer representative management data;
retrieving data about similar deals from a deal knowledge base based on an encoded input question;
generating a prompt based on the encoded input question and data about similar deals from a deal knowledge base;
feeding the prompt to a causal inference model to generate next action recommendations; and
ranking the next action recommendations.

16. The method of claim 15, wherein the deal knowledge base includes information about similar deals at the same stage, similar prospects, and previously generated actions.

17. The method of claim 15, wherein the causal inference model evaluates potential next actions and determines which next action will increase probability of a deal closing based on stage of a deal, correspondence data, and actions performed in previous deals.

18. A non-transitory computer-readable medium storing a set of instructions for streamlining a deal pipeline based on language large models, the set of instructions comprising:
one or more instructions that, when executed by one or more processors of a device, cause the device to:
encode an input query into a numerical representation in a business domain;
retrieve data from a deal knowledge base based on the numerical representation;
generate a prompt based on the encoded input query and data retrieved from the deal knowledge base;
feed the prompt to a generic-trained language model; and
rank responses provided by the generic-trained language model, wherein the responses are related to at least a deal pipeline.

19. A system for streamlining a deal pipeline based on language large models comprising:
one or more processors configured to:
encode an input query into a numerical representation in a business domain;
retrieve data from a deal knowledge base based on the numerical representation;
generate a prompt based on the encoded input query and data retrieved from the deal knowledge base;
feed the prompt to a generic-trained language model; and
rank responses provided by the generic-trained language model, wherein the responses are related to at least a deal pipeline.
